(19) United States
(12) Patent Application Publication
(10) Pub. No.: US 2020/0016957 A1
(43) Pub. Date: Jan. 16, 2020

(54) VEHICULAR AIR CONDITIONING APPARATUS

(71) Applicant: MITSUBISHI HEAVY INDUSTRIES THERMAL SYSTEMS, LTD., Tokyo (JP)

(72) Inventor: Noriyuki CHIKAGAWA, Tokyo (JP)

(73) Assignee: MITSUBISHI HEAVY INDUSTRIES THERMAL SYSTEMS, LTD., Tokyo (JP)

(21) Appl. No.: 16/497,674

(22) PCT Filed: Apr. 12, 2018
(86) PCT No.: PCT/JP2018/015368

§ 371 Date: Sep. 25, 2019

(30) Foreign Application Priority Data
May 15, 2017 (JP) 2017-096637

(51) Int. Cl. B60H 1/32; B60H 1/22

(52) U.S. Cl. CPC B60H 1/3202; B60H 2001/3286; B60H 1/2225

(57) ABSTRACT

An object of the present invention is to provide a vehicular air conditioning apparatus capable of varying the temperature of air that has passed through a heater core in the up-down direction of the heater core while achieving downsizing. The vehicular air conditioning apparatus includes an electric heater (43) that is provided in a flow channel defined by a housing on the downstream side of an evaporator, that includes heater circuits (48, 49), and that configures a heater core (17) that heats air cooled by the evaporator, and a control device (25) that separately controls the heater circuits (48, 49). The heater circuits (48, 49) are arranged in the up-down direction of the heater core (17).

### TECHNICAL FIELD

The present invention relates to a vehicular air conditioning apparatus.

This application claims priority based on JP 2017-096637 A filed in Japan on May 15, 2017, of which the contents are incorporated herein by reference.

### BACKGROUND ART

As a vehicular air conditioning apparatus, there is an apparatus that appropriately mixes cold air generated through an evaporator and hot air generated through a heater core by adjusting an opening amount of an air mixing damper, and that blows out air of a desired temperature.

However, during development, when adjusting the temperature of the air by mixing the cold air and the hot air using the air mix damper, there has been a problem in that time is required to adjust the temperature.

In addition, when the air mix damper is used, since an area is required for disposing the air mix damper in the front-back direction of the vehicle, it has been difficult to downsize the vehicular air conditioning apparatus.

Patent Document 1 discloses a vehicular heat pump-type air conditioning apparatus (a vehicular air conditioning apparatus) that does not include an air mix damper.

Specifically, Patent Document 1 discloses a vehicular heat pump-type air conditioning apparatus in which air blown into a vehicle cabin is at least cooled by an indoor heat exchanger, hot water heated by an electric heater outside the vehicle cabin is caused to flow into a heater core, and the heater core heats the blown air.

### CITATION LIST

Patent Document
Patent Document 1: JP H06-293211 A

### SUMMARY OF INVENTION

### Technical Problem

The vehicular air conditioning apparatus disclosed in Patent Document 1 is configured such that hot water heated by an electric heater is caused to flow into a heater core. Thus, the temperature of the entire electric heater can be increased, or the temperature of the entire electric heater can be reduced.

However, in the case of the vehicular air conditioning apparatus disclosed in Patent Document 1, temperature distribution of the blown air that has passed through the heater core is substantially uniform. Thus, for example, it has been difficult to cause the temperature of the air supplied to foot blown-out ports to be higher than the temperature of the air supplied to defroster blown-out ports and face blown-out ports. In other words, it has been difficult to vary the temperature of the blown-out air that has passed through the heater core.

Thus, an object of the present invention is to provide a vehicular air conditioning apparatus capable of varying the temperature of air that has passed through a heater core in the up-down direction of the heater core, while achieving downsizing.

### Solution to Problem

In order to solve the problems described above, a vehicular air conditioning apparatus according to an aspect of the present invention includes a housing defining a flow channel through which air flows and configured to guide the air into a vehicle cabin via a plurality of blown-out ports, an evaporator provided in the flow channel and configured to cool externally supplied air, an electric heater provided in the flow channel on a downstream side of the evaporator, the electric heater including a plurality of heater circuits, and configuring a heater core that heats the air cooled by the evaporator, and a control device configured to separately control the plurality of heater circuits. The plurality of heater circuits includes heater circuits arranged in an up-down direction of the heater core.

According to the present invention, by including the plurality of heater circuits that configure the electric heater, and the control device that separately controls the plurality of heater circuits, and by the plurality of heater circuits including the heater circuits arranged in the up-down direction of the heater core, control can be performed by the control device such that the temperature of an upper portion of the heater core differs from the temperature of a lower portion of the heater core. In addition, since an air mixing damper is not required, downsizing can be achieved.

Thus, the temperature of the air that has passed through the heater core can be varied in the up-down direction of the heater core while achieving the downsizing.

As a result, for example, the temperature of air blown out from defroster blown-out ports and face blown-out ports can be made to differ from the temperature of air blown out from foot blown-out ports.

Specifically, for example, by increasing the temperature of the air blown out from the foot blown-out ports, the temperature of the air blown out from the face blown-out ports can be made lower than the temperature of the air blown out from the foot blown-out ports.

Further, in the vehicular air conditioning apparatus according to the above-described aspect of the present invention, the plurality of heater circuits may include heater circuits arranged in a width direction of the flow channel.

In this way, by the plurality of heater circuits including the heater circuits arranged in the width direction of the flow channel, the temperature of a right portion of the heater core (a portion corresponding to a right seat) can be made to differ from the temperature of a left portion of the heater core (a portion corresponding to a left seat) in a left-right direction that is the width direction of the flow channel.

As a result, the temperature of the air blown out from blown-out ports for the left seat can be made to differ from the temperature of the air blown out from blown-out ports for the right seat. Thus, depending on preferences of passengers sitting in the left seat and the right seat, the temperature of the air blown out from the blown-out ports can be changed.

Further, in the vehicular air conditioning apparatus according to the above-described aspect of the present invention, the heater core may include four of the heater circuits, and the four heater circuits may be provided in the up-down direction of the heater core and in the width direction of the flow channel so as to divide the heater core into four sections.

In this way, by arranging the four heater circuits in the up-down direction of the heater core and in the width direction of the flow channel (the left-right direction) so as to divide the heater core into the four sections, the temperatures of an upper left portion of the heater core, a lower left portion of the heater core, an upper right portion of the heater core, and a lower right portion of the heater core can be made to vary.

As a result, depending on the preferences of the passengers sitting in the right seat and the left seat, the temperature of the air blown into the vehicle cabin can be made to vary.

Further, in the vehicular air conditioning apparatus according to the above-described aspect of the present invention, the heater core may be configured by a plurality of electric heaters including heater circuits.

In this way, even when the heater core is configured by the plurality of heaters including the heater circuits, a similar effect to that of a case when a single electric heater includes a plurality of heater circuits can be obtained.

Further, in the vehicular air conditioning apparatus according to the above-described aspect of the present invention, the plurality of blown-out ports may include a first defroster blown-out port, a first face blown-out port, and a first foot blown-out port that are provided on a left side of the vehicle cabin, and a second defroster blown-out port, a second face blown-out port, and a second foot blown-out port that are provided on a right side of the vehicle cabin. The housing may include a housing body defining the flow channel, a first defroster duct provided in the housing body and causing the first defroster blown-out port to communicate with the flow channel, a first face duct provided in the housing body and causing the first face blown-out port to communicate with the flow channel, a first foot duct provided in the housing body and causing the first foot blown-out port to communicate with the flow channel, a second defroster duct causing the second defroster blown-out port to communicate with the flow channel, a second face duct provided in the housing body and causing the second face blown-out port to communicate with the flow channel, and a second foot duct provided in the housing body and causing the second foot blown-out port to communicate with the flow channel.

With such a configuration, at least the temperature of the air blown out from the first defroster blown-out port, the first face blown-out port, the second defroster blown-out port, and the second face blown-out port can be made to differ from the temperature of the air blown out from the first foot blown-out port and the second foot blown-out port.

Further, in the vehicular air conditioning apparatus according to an aspect of the present invention, during heating, the plurality of heater circuits may be controlled such that a temperature in a lower portion of the heater core is higher than a temperature in an upper portion of the heater core.

By the control device performing such control, the temperature of the air blown out from the foot blown-out ports can be increased, and the temperature of the air blown out from the face blown-out ports can be made lower than the temperature of the air blown out from the foot blown-out ports. As a result, the face of the passenger of the vehicle can be prevented from becoming hot, while being able to sufficiently warm the feet of the passenger.

Further, in the vehicular air conditioning apparatus according to an aspect of the present invention, the evaporator may include a pair of first surfaces through which the externally supplied air circulates, the heater core may include a pair of second surfaces through which the air cooled by the evaporator passes, and a size of an outer shape of the second surface may be equal to a size of an outer shape of the first surface.

In this way, by causing the size of the outer shape of the second surface of the heater core, through which the air that has passed through and been cooled by the evaporator passes, to be equal to the size of the outer shape of the first surface of the evaporator, through which the externally supplied air circulates, it is possible to prevent the air flow from being obstructed by the heater core when the cooled air passes through the heater core. As a result, the air flow rate can be sufficiently secured during cooling.

### Advantageous Effect of Invention

According to the present invention, the temperature of the air that has passed through the heater core in the up-down direction of the heater core can be varied while achieving the downsizing.

### BRIEF DESCRIPTION OF DRAWINGS

FIG. 1 is a cross-sectional view schematically illustrating an outline configuration of a vehicular air conditioning apparatus according to a first embodiment of the present invention.

FIG. 2 is a plan view of a portion of the vehicular air conditioning apparatus illustrated in FIG. 1 as viewed from A.

FIG. 3 is a diagram of an evaporator illustrated in FIG. 1 as viewed from B.

FIG. 4 is a diagram of a heater core illustrated in FIG. 1 as viewed from C.

FIG. 5 is a diagram schematically illustrating a heater core according to a modified example of the first embodiment of the present invention.

FIG. 6 is a diagram schematically illustrating a heater core according to a second embodiment of the present invention.

FIG. 7 is a diagram schematically illustrating a heater core according to a modified example of the second embodiment of the present invention.

### DESCRIPTION OF EMBODIMENTS

Embodiments in which the present invention is applied will be described in detail below with reference to the drawings.

### First Embodiment

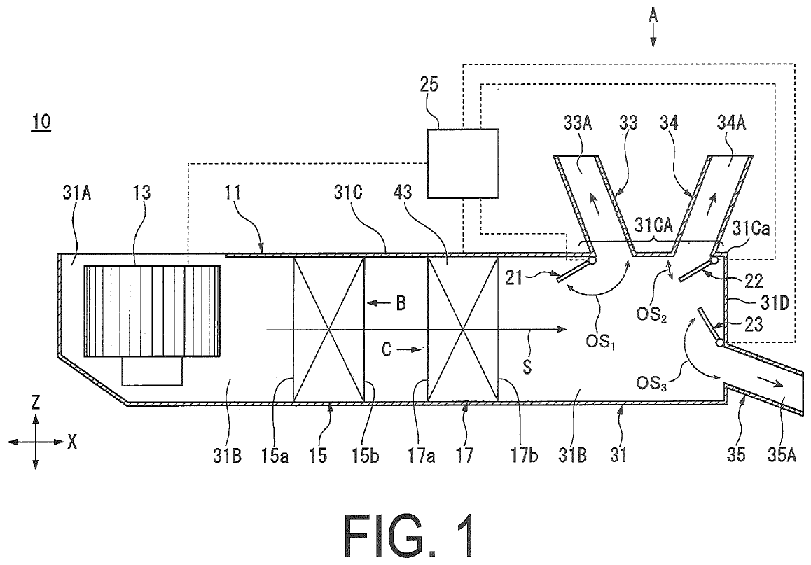

A vehicular air conditioning apparatus 10 according to a first embodiment will be described with reference to FIG. 1 to FIG. 4.

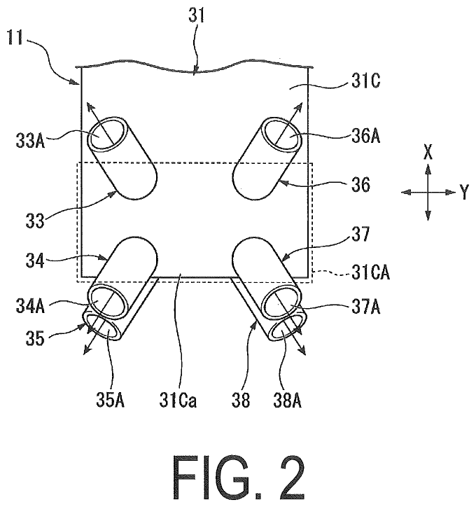

FIG. 1 is a cross-sectional view of the vehicular air conditioning apparatus when it is cut so as to pass through a first defroster duct 33, a first face duct 34, and a first foot duct 35 that are illustrated in FIG. 2. In FIG. 1, an X direction indicates an extension direction of a housing 11 configuring the vehicular air conditioning apparatus 10, and Z indicates an up-down direction (a vertical direction) of a heater core 17 orthogonal to the X direction. Further, in FIG. 1, S indicates a movement method of air flowing through a flow channel 31B (hereinafter referred to as an “S direction”), OS₁ indicates an opening/closing direction of a defroster damper 21 (hereinafter referred to as an “OS₁ direction”), OS₂ indicates an opening/closing direction of a face damper 22 (hereinafter referred to as an “OS₂ direction”), and OS₃ indicates an opening/closing direction of a foot damper 23 (hereinafter referred to as an “OS₃ direction”).

In FIG. 2, common numerals are assigned to similar components for the structural bodies illustrated in FIG. 1. In FIG. 2, a Y direction indicates a width direction of a flow channel 31B orthogonal to the X direction and the Z direction.

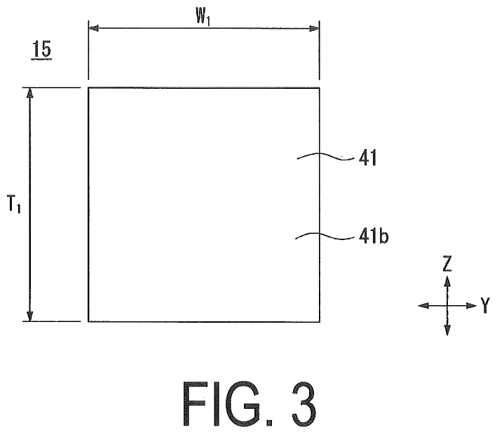

In FIG. 3, common numerals are assigned to similar components for the structural bodies illustrated in FIG. 1. In FIG. 3, T₁ indicates a height of an evaporator 15 (hereinafter referred to as a “height T₁”), and W₁ indicates a width of the evaporator 15 in the Y direction (hereinafter referred to as a “width W₁”).

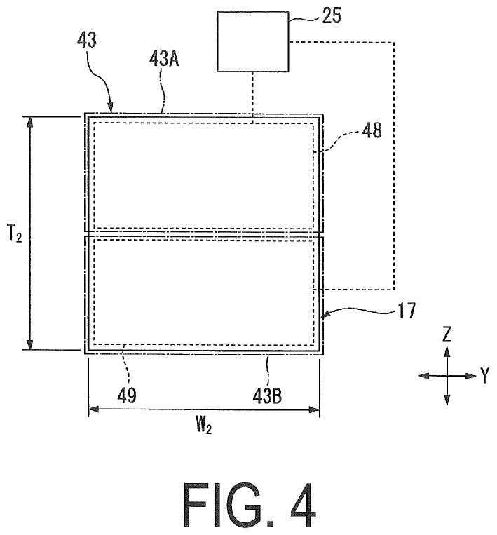

In FIG. 4, for convenience of explanation, a control device 25, which is not a component of the heater core 17, is also illustrated. In FIG. 4, T₂ indicates a height of the heater core 17 (hereinafter referred to as a “height T₂”), and W₂ indicates a width of the heater core 17 in the Y direction (hereinafter referred to as a “width W₂”). In FIG. 4, common numerals are assigned to similar components for the structural bodies illustrated in FIG. 1.

The vehicular air conditioning apparatus 10 includes the housing 11, a blower 13, the evaporator 15, the heater core 17, the defroster damper 21, the face damper 22, the foot damper 23, and the control device 25.

The housing 11 includes a housing body 31, the first defroster 33, the first face duct 34, the first foot duct 35, a second defroster duct 36, a second face duct 37, and a second foot duct 38.

The housing body 31 extends in the X direction. The housing body 31 includes an intake port 31A, the flow channel 31B, an upper plate 31C, and an end plate 31D.

The intake port 31A is provided at a first end portion of both end portions of the housing body 31 disposed in the X direction. The intake port 31A is communicated with the flow channel 31B. The intake port 31A is an opening for taking in outside air or air in a vehicle cabin (hereinafter simply referred to as “air”).

The first defroster duct 33 is provided in a portion located on the left side of a second end portion 31CA (including a second end 31Ca) of the upper plate 31C. The first defroster duct 33 extends above the upper plate 31C.

The first defroster duct 33 has a defroster flow channel 33A defined therein. The defroster flow channel 33A is communicated with the flow channel 31B and a first defroster blown-out port (not illustrated), which is provided on a left seat (a passenger seat in the case of a right-hand drive) side inside the vehicle cabin. When the defroster damper 21 is in an open state (a state illustrated in FIG. 1), the first defroster duct 33 guides the air having passed through the evaporator 15 and the heater core 17 to the first defroster blown-out port.

The first face duct 34 is provided on a portion located on the left side of the second end portion 31CA (including the second end 31Ca) of the upper plate 31C. The first face duct 34 is disposed between the first defroster duct 33 and the second end 31Ca. The first face duct 34 extends above the upper plate 31C.

The first face duct 34 has a face flow channel 34A defined therein. The face flow channel 34A is communicated with the flow channel 31B and a first face blown-out port (not illustrated) provided on the left seat side inside the vehicle cabin. When the face damper 22 is in an open state (a state illustrated in FIG. 1), the first face duct 34 guides the air that has passed through the evaporator 15 and the heater core 17 to the first face blown-out port. Note that in FIG. 1, as an example, a state is illustrated in which the face damper 22 is open.

The first foot duct 35 is provided in a lower portion of a portion located on the left side of the end plate 31D.

The first foot duct 35 has a foot flow channel 35A defined therein. The foot flow channel 35A is communicated with the flow channel 31B and a first foot blown-out port (not illustrated) provided on the left seat side inside the vehicle cabin. When the foot damper 23 is in an open state (a state illustrated in FIG. 1), the first foot duct 35 guides the air that has passed through the evaporator 15 and the heater core 17 to the first foot blown-out port.

The second defroster duct 36 is provided in a portion located on the right side of the second end portion 31CA of the upper plate 31C. The second defroster duct 36 extends above the upper plate 31C.

The second defroster duct 36 has a defroster flow channel 36A defined therein. The defroster flow channel 36A is communicated with the flow channel 31B and a second defroster blown-out port (not illustrated) provided on a right seat (a driver's seat in the case of the right-hand drive, for example) side inside the vehicle cabin. Note that a defroster damper (not illustrated) that opens and closes the second defroster duct 36 is provided on an inlet side of the second defroster duct 36.

The second face duct 37 is provided on a portion located on the right side of the second end portion 31CA of the upper plate 31C. The second face duct 37 is disposed between the second defroster duct 36 and the second end 31Ca. The second face duct 37 extends above the upper plate 31C.

The second face duct 37 has a face flow channel 37A defined therein. The face flow channel 37A is communicated with the flow channel 31B and a face blown-out port (not illustrated) provided on the right seat side inside the vehicle cabin. Note that a face damper (not illustrated) that opens and closes the second face duct 37 is provided on an inlet side of the second face duct 37.

The second foot duct 38 is provided in the lower portion of a portion located on the right side of the end plate 31D.

The second foot duct 38 has a foot flow channel 38A defined therein. The foot flow channel 38A is communicated with the flow channel 31B and a foot blown-out port (not illustrated) provided on the right seat side inside the vehicle cabin. Note that a foot damper (not illustrated) that opens and closes the second foot duct 38 is provided on an inlet side of the second foot duct 38.

The blower 13 is provided near the intake port 31A in the flow channel 31B. The blower 13 sucks the air from the intake port 31A and feeds the sucked air by pressure into the flow channel 31B located on a downstream side of the blower 13.

The blower 13 is electrically connected to the control device 25. The blower 13 is configured to be controllable by the control device 25.

The evaporator 15 is provided in the flow channel 31B located on the downstream side of the blower 13. The evaporator 15 circulates externally supplied air. The evaporator 15 cools the air supplied from the blower 13. The shape of the evaporator 15 is a rectangular shape in a state viewed from B. The evaporator 15 has a pair of first surfaces 15a and 15b arranged in the X direction. The pair of first surfaces 15a and 15b are wholly exposed by the flow channel 31B. The shape of each of the pair of first surfaces 15a and 15b is a rectangular shape.

The first surface 15a is a surface to which the air fed by pressure from the blower 13 is supplied. The first surface 15b is a surface disposed on the heater core 17 side. After passing through the first surface 15b, the air cooled by the evaporator 15 is guided to the flow channel 31B located on the downstream side of the evaporator 15. The pair of first surfaces 15a and 15b are the same in area and have the same shape.

As the above-described evaporator 15, an evaporator can be used, for example.

The heater core 17 is provided in the flow channel 31B while being located on the downstream side of the evaporator 15 and on an upstream side of the first and second defroster ducts 33 and 36. The heater core 17 is disposed to be separated from the evaporator 15 in the X direction.

The heater core 17 is configured by a single electric heater 43 and disposed in the flow channel 31B. The heater core 17 has second surfaces 17a and 17b.

The pair of second surfaces 17a and 17b are surfaces arranged in the X direction. The pair of second surfaces 17a and 17b are wholly exposed by the flow channel 31B. The shape of each of the pair of second surfaces 17a and 17b is a rectangular shape.

The second surface 17a is a surface facing the first surface 15b. The air cooled by the evaporator 15 is supplied to the second surface 17a.

The second surface 17b is a surface disposed on the end plate 31D side. The second surface 17b faces an inner surface of the end plate 31D. The air that has passed through the heater core 17 is supplied to the flow channel 31B located on the downstream side of the heater core 17, by passing through the second face 17b. The pair of second surfaces 17a and 17b are the same in area and have the same shape.

Further, the size of the outer shape of each of the second surfaces 17a and 17b may be configured to be equal to the size of the outer shape of each of the first surfaces 15a and 15b, for example. In other words, the height T₂ of the heater core 17 may be equal to the height T₁ of the evaporator 15, and the width W₂ of the heater core 17 may be equal to the width W₁ of the evaporator 15.

In this way, by making the size of the outer shape of each of the second surfaces 17a and 17b equal to the size of the outer shape of each of the first surfaces 15a and 15b, it is possible to prevent the air flow from being obstructed by the heater core 17 when the cooled air passes through the heater core 17. As a result, an air flow rate can be sufficiently secured during cooling.

The electric heater 43 has a surface facing the second surfaces 17a and 17b. The electric heater 43 heats the air cooled by the evaporator 15 when the electric heater 43 is in an on state, and when it is in an off state, allows the air cooled by the evaporator 15 to pass through as it is, without heating the air. The electric heater 43 has a rectangular shape when viewed from C.

The electric heater 43 includes two heater circuits 48 and 49 (a plurality of heater circuits).

The heater circuit 48 is provided in an upper portion 43A of the electric heater 43 (an upper portion of the heater core 17). The heater circuit 48 is electrically connected to the control device 25. The heater circuit 48 is thus configured to be controllable by the control device 25.

The heater circuit 49 is provided in a lower portion 43B of the electric heater 43 (a lower portion of the heater core 17). The heater circuit 49 is electrically separated from the heater circuit 48. The heater circuit 49 is electrically connected to the control device 25. The heater circuit 49 is thus configured to be controllable by the control device 25.

The defroster dampers 21 are respectively provided on an inlet side of the first defroster duct 33 and on the inlet side of the second defroster duct 36. The defroster dampers 21 are configured to be rotatable in the OS₁ direction. The defroster dampers 21 rotate in the OS₁ direction to open and close the first and second defroster ducts 33 and 36.

The defroster dampers 21 are electrically connected to the control device 25. The defroster dampers 21 are thus configured such that operations thereof are controllable by the control device 25.

The face dampers 22 are respectively provided on an inlet side of the first face duct 34 and on the inlet side of the second face duct 37. The face damper 22 is configured to be rotatable in the OS₂ direction. The face dampers 22 rotate in the OS₂ direction to open and close the first and second face ducts 34 and 37.

The face dampers 22 are electrically connected to the control device 25. The face dampers 22 are thus configured such that operations thereof are controllable by the control device 25.

The foot dampers 23 are respectively provided on an inlet side of the first foot duct 35 and on the inlet side of the second foot duct 38. The foot dampers 23 are configured to be rotatable in the OS₃ direction. The foot dampers 23 rotate in the OS₃ direction to open and close the first and second foot ducts 35 and 38.

The foot dampers 23 are electrically connected to the control device 25. The foot dampers 23 are thus configured such that operations thereof are controllable by the control device 25.

When a signal is input, in response to the signal, the control device 25 controls the heater circuits 48 and 49, the defroster dampers 21, the face dampers 22, and the foot dampers 23.

Here, processing performed by the control device 25 will be described using an example in which the control device 25 receives an instruction signal during heating, the instruction signal instructing the temperature of the air blown out from the first and second foot blown-out ports to be higher than the temperature of the air blown out from the first defroster blown-out port, the second defroster blown-out port, the first face blown-out port, and the second face blown-out port.

When the control device 25 receives the above-described instruction signal, the control device 25 causes the blower 13 to be driven in a state in which the defroster dampers 21, the face dampers 22, and the foot dampers 23 are open, and controls the heater circuits 48 and 49 such that the temperature of the lower portion 43B of the electric heater 43 is higher than the temperature of the upper portion 43A of the electric heater 43.

As a result, after being heated by the upper portion 43A of the electric heater 43, the air passing through the upper portion 43A of the electric heater 43 is supplied to the first defroster duct 33, the first face duct 34, the second defroster duct 36, and the second face duct 37.

On the other hand, by being heated by the lower portion 43B, the air passing through the lower portion 43B of the electric heater 43 has a temperature higher than that of the air passing through the upper portion 43A of the electric heater 43, and after that, is supplied to the first and second foot ducts 35 and 38.

As a result of the control device 25 performing such control, the face of a passenger of the vehicle can be prevented from becoming hot, while being able to sufficiently warm the feet of the passenger.

Note that instruction signals other than the above-described instruction signal are also input to the control device, and on the basis of the input instruction signals, the control device performs control of the heater circuits 48 and 49, and opening and closing control of the defroster dampers 21, the face dampers 22, and the foot dampers 23.

According to the vehicular air conditioning apparatus 10 of the first embodiment, by including the heater circuit 48 disposed in the upper portion 43A of the electric heater 43, which serves as the heater core 17, the heater circuit 49 disposed in the lower portion 43B of the electric heater 43, and the control device 25 that individually controls the heater circuits 48 and 49, the control can be performed by the control device 25 such that the temperature of the upper portion 43A of the electric heater 43 differs from the temperature of the lower portion 43B of the electric heater 43. In addition, since an air mixing damper is not required, downsizing of the apparatus can be achieved.

Thus, the temperature of the air that has passed through the heater core 17 can be varied in the up-down direction of the heater core 17 while achieving the downsizing.

As a result, depending on the purpose, the temperature of the air blown out from the first defroster blown-out port, the first face blown-out port, the second defroster blown-out port, and the second face blown-out port can be made to differ from the temperature of the air blown out from the first foot blown-out port and the second foot blown-out port.

Specifically, for example, by increasing the temperature of the air blown out from the first and second foot blown-out ports, the temperature of the air blown out from the first and second face blown-out ports can be made lower than the temperature of the air blown out from the first and second foot blown-out ports.

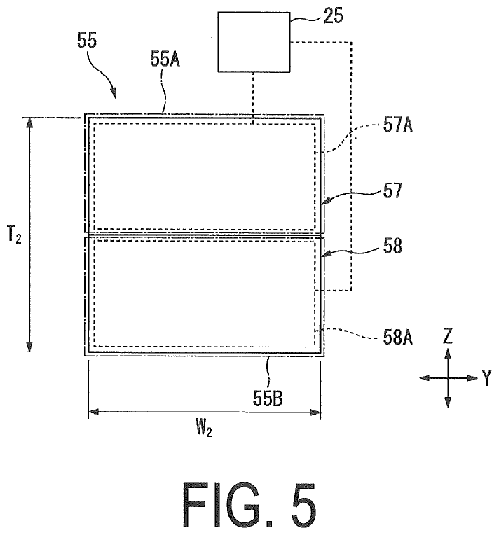

Here, a heater core 55 according to a modified example of the first embodiment will be described with reference to FIG. 5. In FIG. 5, the control device 25, which is not a component of the heater core 55, is also illustrated. In FIG. 5, common numerals are assigned to similar components for the structural bodies illustrated in FIG. 1.

The heater core 55 is configured in the same manner as the heater core 17 except that the heater core 55 includes electric heaters 57 and 58 in place of the single electric heater 43 that configures the heater core 17 described in the first embodiment.

The electric heater 57 configures an upper portion 55A of the heater core 55. The electric heater 57 includes a heater circuit 57A electrically connected to the control device 25.

The electric heater 58 configures a lower portion 55B of the heater core 55. The electric heater 58 includes a heater circuit 58A electrically connected to the control device 25.

In this way, when the heater core 55 is configured by the two electric heaters 57 and 58, a similar effect can be obtained to that of the case in which the heater core 17 is configured by the above-described single electric heater 43.

### Second Embodiment

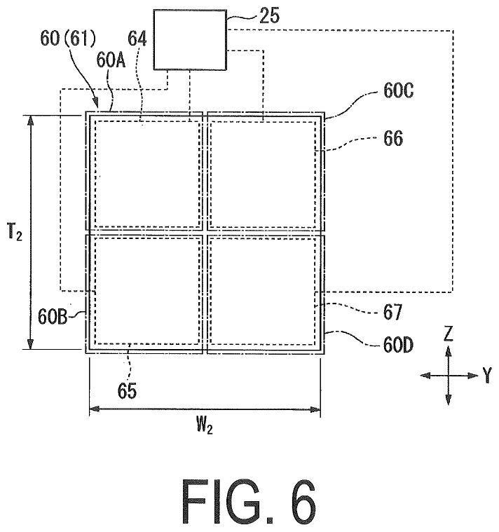

A heater core 60 according to a second embodiment will be described with reference to FIG. 6. In FIG. 6, common numerals are assigned to similar components for the structural bodies illustrated in FIG. 4.

The heater core 60 has an upper left region 60A, a lower left region 60B, an upper right region 60C, and a lower right region 60D, which are regions formed by dividing the heater core 60 into four sections along the up-down and left-right directions.

The lower left region 60B is disposed below the upper left region 60A. The upper right region 60C is disposed on the right side of the upper left region 60A. The lower right region 60D is disposed below the upper right region 60C.

The heater core 60 is configured by a single electric heater 61. The electric heater 61 includes heater circuits 64 to 67. Each of the heater circuits 64 to 67 is an independent circuit.

The heater circuit 64 is disposed in the upper left region 60A. The heater circuit 65 is disposed in the lower left region 60B. The heater circuit 66 is disposed in the upper right region 60C. The heater circuit 67 is disposed in the lower right region 60D.

In other words, in the second embodiment, a plurality of the heater circuits (two of the heater circuits in the case of the second embodiment) are provided not only in the Z direction (the up-down direction), but also in the Y direction (the width direction of the flow channel 31B illustrated in FIG. 1).

The heater circuits 64 and 65 are circuits used when heating the air blown toward the left seat. On the other hand, the heater circuits 66 and 67 are circuits used when heating the air blown toward the right seat. The heater circuits 64 to 67 are electrically connected to the control device 25.

According to the heater core 60 of the second embodiment, by including the four heater circuits 64 to 67 arranged in the Z direction and the Y direction and electrically connected to the control device 25, the temperature of the air blown out from the first defroster blown-out port and the first face blown-out port for the left seat can be made to differ from the temperature of the air blown out from the second defroster blown-out port and the second face blown-out port for the right seat, and also, the temperature of the air blown out from the first foot blown-out port for the left seat can be made to differ from the temperature of the air blown out from the second foot blown-out port for the right seat.

As a result, depending on preferences of passengers sitting in the right seat and the left seat, the temperature of the air blown into the vehicle cabin can be made to vary.

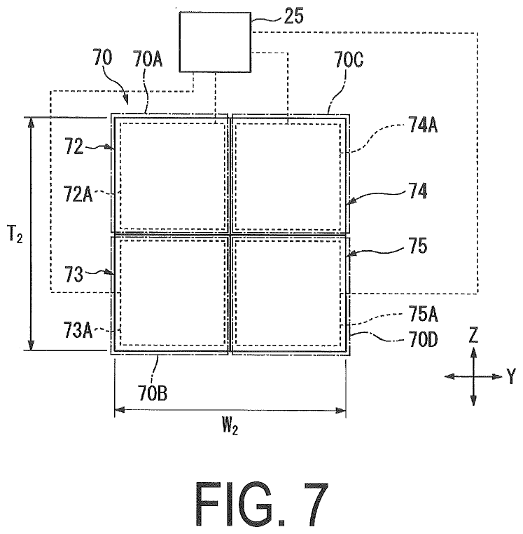

Here, a heater core 70 according to a modified example of the second embodiment will be described with reference to FIG. 7. In FIG. 7, the control device 25, which is not a component of the heater core 70, is also illustrated. In FIG. 7, common numerals are assigned to similar components for the structural bodies illustrated in FIG. 6.

The heater core 70 is configured in the same manner as the heater core 60 except that the heater core 70 includes electric heaters 72 to 75 in place of the single electric heater 61 that configures the heater core 60 described in the second embodiment.

The heater core 70 has an upper left region 70A, a lower left region 70B, an upper right region 70C, and a lower right region 70D, which are regions formed by dividing the heater core 70 into four sections along the up-down and left-right directions.

The electric heater 72 configures the upper left region 70A of the heater core 70. The electric heater 72 includes a heater circuit 72A electrically connected to the control device 25.

The electric heater 73 configures the lower left region 70B of the heater core 70. The electric heater 73 includes a heater circuit 73A electrically connected to the control device 25.

The electric heater 74 configures the upper right region 70C of the heater core 70. The electric heater 74 includes a heater circuit 74A electrically connected to the control device 25.

The electric heater 75 configures the lower right region 70D of the heater core 70. The electric heater 75 includes a heater circuit 75A electrically connected to the control device 25.

Each of the electric heaters 72 to 74 is electrically connected to the control device 25.

In this way, when the heater core 70 is configured by the four electric heaters 72 to 74 arranged in the Z direction and the Y direction, a similar effect can be obtained to that of the heater core 60 described in the second embodiment.

Although preferable embodiments of the present invention have been described above in detail, the present invention is not limited to those specific embodiments. Various modifications and changes can be made to the embodiments without departing from the scope and spirit of the present invention as described in the claims.

For example, in the first embodiment, the description is given using an example in which the two heater circuits (specifically, the heater circuits 48 and 49, or the heater circuits 57A and 58A) are arranged in the Z direction, but as necessary, three or more of the heater circuits may be arranged in the Z direction.

Further, in the second embodiment, the description is given using an example in which two of the heater circuits are arranged respectively in the Y direction and the Z direction, but as necessary, three or more of the heater circuits may be arranged in the Y direction and the Z direction, respectively.

### INDUSTRIAL APPLICABILITY

The present invention can be applied to a vehicular air conditioning apparatus.

### REFERENCE SIGNS LIST

10 Vehicular air conditioning apparatus
11 Housing
13 Blower
15 Evaporator
15a, 15b First surface
17, 55, 60, 70 Heater core
21 Defroster damper
22 Face damper
23 Foot damper
25 Control device
31 Housing body
31A Intake port
31B Flow channel
31C Upper plate
31Ca Second end
31CA Second end portion
31D End plate
33 First defroster duct
33A, 36A Defroster flow channel
34 First face duct
34A, 37A Face flow channel
35 First foot duct
35A, 38A Foot flow channel
36 Second defroster duct
37 Second face duct
38 Second foot duct
43, 57, 58, 61, 72 to 75 Electric heater
43a, 43b Second surface
45A, 55A Upper portion
45B, 55B Lower portion
48, 49, 57A, 58A, 64 to 67, 72A to 75A Heater circuit
60A, 70A Upper left region
60B, 70B Lower left region
60C, 70C Upper right region
60D, 70D Lower right region
OS₁, OS₂, OS₃, S Direction
T₁, T₂ Height
W₁, W₂ Width

1.-7. (canceled)

8. A vehicular air conditioning apparatus comprising:
a housing defining a flow channel through which air flows and configured to guide the air into a vehicle cabin via a plurality of blown-out ports;
an evaporator provided in the flow channel and configured to cool externally supplied air;
an electric heater provided in the flow channel on a downstream side of the evaporator, the electric heater including a plurality of heater circuits and configuring a heater core that heats the air cooled by the evaporator; and
a control device configured to separately control the plurality of heater circuits, wherein
the plurality of heater circuits includes heater circuits arranged in an up-down direction of the heater core;
the evaporator includes a pair of first surfaces through which the externally supplied air circulates;
the heater core includes a pair of second surfaces through which the air cooled by the evaporator passes;
a size of an outer shape of the second surface is equal to a size of an outer shape of the first surface;
the pair of first surfaces and the pair of second surfaces are wholly exposed by the flow channel; and
in a movement direction of the air flowing through the flow channel, the first surface, of the pair of first surfaces, that is disposed on the heater core side faces the second surface, of the pair of second surfaces, that is disposed on the evaporator side.

9. The vehicular air conditioning apparatus according to claim 8, wherein
the plurality of heater circuits includes heater circuits arranged in a width direction of the flow channel.

10. The vehicular air conditioning apparatus according to claim 8, wherein
the heater core includes four of the heater circuits; and
the four heater circuits are provided in the up-down direction of the heater core and in the width direction of the flow channel so as to divide the heater core into four sections.

11. The vehicular air conditioning apparatus according to claim 8, wherein
the heater core is configured by a plurality of electric heaters including heater circuits.

12. The vehicular air conditioning apparatus according to claim 8, wherein
the plurality of blown-out ports include a first defroster blown-out port, a first face blown-out port, and a first foot blown-out port that are provided on a left side of the vehicle cabin, and a second defroster blown-out port, a second face blown-out port, and a second foot port that are provided on a right side of the vehicle cabin; and
the housing includes
a housing body defining the flow channel,
a first defroster duct provided in the housing body and causing the first defroster blown-out port to communicate with the flow channel,
a first face duct provided in the housing body and causing the first face blown-out port to communicate with the flow channel,
a first foot duct provided in the housing body and causing the first foot blown-out port to communicate with the flow channel,
a second defroster duct provided in the housing body and causing the second defroster blown-out port to communicate with the flow channel,
a second face duct provided in the housing body and causing the second face blown-out port to communicate with the flow channel, and
a second foot duct provided in the housing body and causing the second foot blown-out port to communicate with the flow channel.

13. The vehicular air conditioning apparatus according to claim 8, wherein
the control device controls the plurality of heater circuits such that, during heating, a temperature in a lower portion of the heater core is higher than a temperature in an upper portion of the heater core.
